(19) United States
(12) Patent Application Publication
(10) Pub. No.: US 2026/0048463 A1
(43) Pub. Date: Feb. 19, 2026

(54) TAPE MOUNTER, PROCESSING APPARATUS, AND METHOD FOR PROCESSING WORKPIECES

(71) Applicant: DISCO CORPORATION, Tokyo (JP)

(72) Inventors: Kentaro TERASHI, Tokyo (JP); Takuto ONAYA, Tokyo (JP); Rei TACHIBANAKI, Tokyo (JP)

(73) Assignee: DISCO CORPORATION, Tokyo (JP)

(21) Appl. No.: 19/294,730

(22) Filed: Aug. 8, 2025

(30) Foreign Application Priority Data
Aug. 19, 2024 (JP) 2024-137573
May 21, 2025 (JP) 2025-084491

(51) Int. Cl. B23Q 7/16

(52) U.S. Cl. CPC B23Q 7/16

(57) ABSTRACT

A tape mounter configured to attach at least one workpiece to a tape, which is attached to a ring frame to close an opening in the ring frame, includes frame rails configured to support a frame set, in which the tape is attached to the ring frame to close the opening; a workpiece movement assembly configured to move the at least one workpiece onto the tape in the frame set supported by the frame rails; a table configured to support a surface of the tape on an opposite side to an attaching surface of the ring frame; and an attaching assembly configured to attach the at least one workpiece moved by the workpiece movement assembly to the attaching surface of the tape supported by the table.

### CROSS REFERENCE TO RELATED APPLICATION

This application is based upon and claims the benefit of priority from the prior Japanese Patent Applications No. 2024-137573 filed on Aug. 19, 2024 and No. 2025-084491 filed on May 21, 2025; the entire contents of which are incorporated herein by reference.

### FIELD

The present disclosure relates to a tape mounter, a processing apparatus, and a method for processing workpieces.

### BACKGROUND

Japanese Patent Application Laid-Open Publication No. 2021-019114 discloses a tape mounter configured to form a workpiece set, in which a workpiece is integrated with a ring frame by means of an attaching tape. The tape mounter disclosed in this publication includes a ring frame holder table to hold the ring frame and a workpiece table to hold the workpiece in an opening on an inner side in the ring frame. The tape mounter disclosed in this publication further includes an attaching device for attaching the tape to an upper surface of the ring frame held on the ring frame holder table and to an upper surface of the workpiece held by the workpiece table.

### SUMMARY

According to the above publication, for attaching a plurality of workpieces to the tape on an inner side of a single ring frame, the tape mounter requires a plurality of workpiece tables to hold the plurality of workpieces. As such, as the number of workpieces to be attached to the tape increases, the tape mounter may need an increased number of workpieces tables, resulting in a complex structure of the attaching device.

The present disclosure has been made in view of such circumstances, and one of the objectives of the present disclosure is to provide a tape mounter, a processing apparatus, and a method for processing workpieces, by which the device and the apparatus may avoid complexity even when the number of workpieces to attach to a tape in a frame set is increased.

According to an aspect of the present disclosure, a tape mounter is configured to attach at least one workpiece to a tape, which is attached to a ring frame to close an opening in the ring frame. The tape mounter includes frame rails configured to support a frame set, in which the tape is attached to the ring frame to close the opening; a workpiece movement assembly configured to move the at least one workpiece onto the tape in the frame set supported by the frame rails; a table configured to support a surface of the tape on an opposite side to an attaching surface of the ring frame; and an attaching assembly configured to attach the at least one workpiece moved by the workpiece movement assembly to the attaching surface of the tape supported by the table.

According to another aspect of the present disclosure, a processing apparatus includes a chuck table configured to hold a workpiece set in which the ring frame and the at least one workpiece are integrated with the tape attached thereto; a processing unit configured to process the at least one workpiece held by the chuck table; a conveyer configured to convey the workpiece set to the chuck table; a frame cassette stage for placing a frame cassette thereon, the frame cassette being configured to store the frame set, in which the tape is attached to the ring frame to close the opening; a workpiece cassette stage for placing a workpiece cassette thereon, the workpiece cassette being configured to store the at least one workpiece; and the tape mounter according to claim 2, the tape mounter being configured to form the workpiece set by attaching the at least one workpiece to the tape in the frame set.

According to the tape mounter of the present disclosure, the workpiece is moved by the workpiece movement assembly onto the tape on the frame set supported by the frame rails, and a plurality of workpieces may be moved and attached to the tape one by one. Accordingly, even when the number of workpieces to be attached to the tape varies, the plurality of workpieces may be processed without increasing the number of devices for holding the workpieces, and complexity of the apparatus may be avoided.

### BRIEF DESCRIPTION OF THE DRAWINGS

FIG. 1 is an exterior perspective view of a cutting apparatus according to an embodiment.

FIG. 2 is an internal perspective view of the cutting apparatus according to the embodiment.

FIG. 3 is a perspective view of a plurality of containers according to the embodiment.

FIG. 4 is an interior perspective view of a lowermost one of the containers according to the embodiment.

FIG. 5 is an interior perspective view of one of the containers in a middle according to the embodiment.

FIG. 6 is an interior perspective view of an uppermost one of the containers according to the embodiment.

FIG. 7 is an exploded view of the uppermost container shown in FIG. 6.

FIG. 8A is an illustrative view of a frame set conveying step. FIG. 8B is an illustrative view of a workpiece conveying step.

FIGS. 9A-9C are illustrative views of a workpiece attaching step.

FIGS. 10A-10B are illustrative views of a workpiece attaching step. FIG. 10C is an illustrative view of a workpiece set conveying step.

FIG. 11 is a block diagram to illustrate an input device and a controller according to a modified example of the embodiment.

FIG. 12 is an exemplary view of an input screen in the input device according to the modified example.

FIG. 13 is an exemplary view of a ring frame data table according to the modified example.

### DESCRIPTION OF EMBODIMENTS

Hereinafter, with reference to the accompanying drawings, an example, in which a processing apparatus according to an embodiment of the present disclosure is applied to a cutting apparatus, will be described. Note that the cutting apparatus according to the illustrative embodiment is not limited to the configuration described below but may be modified optionally.

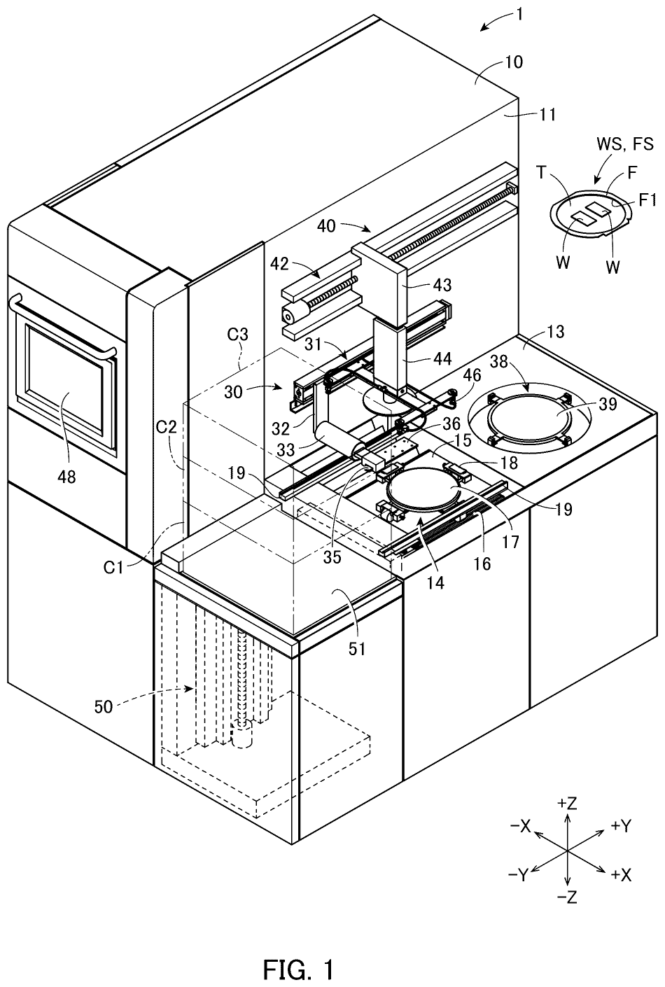

FIG. 1 is an exterior perspective view of the cutting apparatus according to the embodiment. First, an overall configuration of the cutting apparatus 1 will be described with reference to FIG. 1. An X-axis direction, a Y-axis direction, and a Z-axis direction shown in FIG. 1 are orthogonal to one another. The X-axis direction and the Y-axis direction are substantially horizontal directions, and the Z-axis direction is an up-down direction (vertical direction). In the accompanying drawings, a frontward side and a rearward side in the X-axis direction may be referred to as +X side and −X side, respectively; a rightward side and a leftward side in the Y-axis direction may be referred to as +Y side and −Y side, respectively; and an upper side and a lower side in the Z-axis direction may be referred to as +Z side and −Z side, respectively.

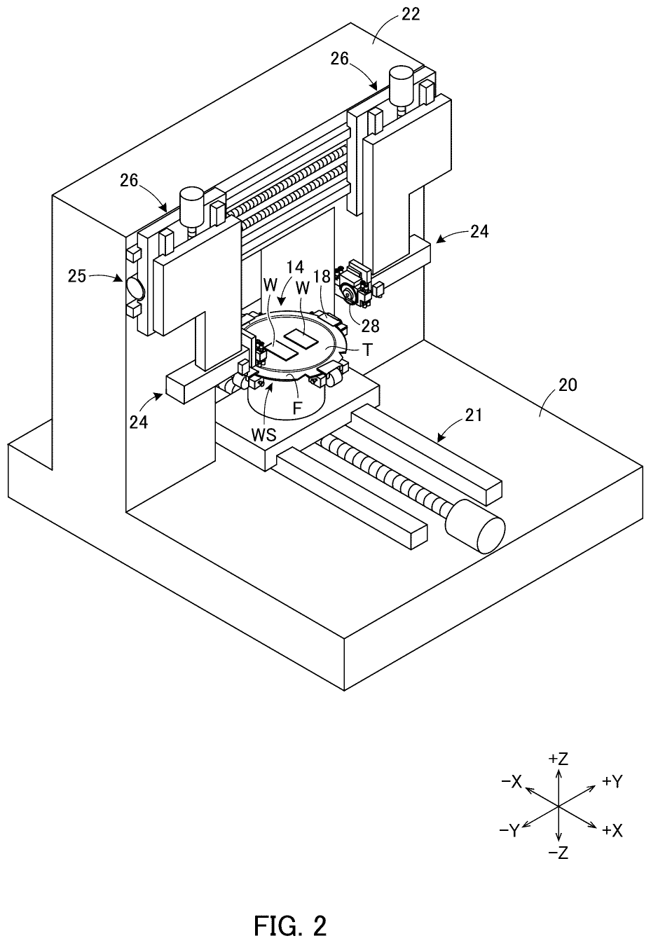

As shown in FIG. 1, the cutting apparatus 1 includes a display device 48, through which operations from an operator may be input, and various processing conditions of the cutting apparatus 1 may be set via the display device 48. The cutting apparatus 1 is configured to move a cutting blade 28 (see FIG. 2) and a workpiece W held on a chuck table 14 relatively based on the conditions set via the display device 48, thereby performing a cutting process along streets on the workpiece W on the chuck table 14.

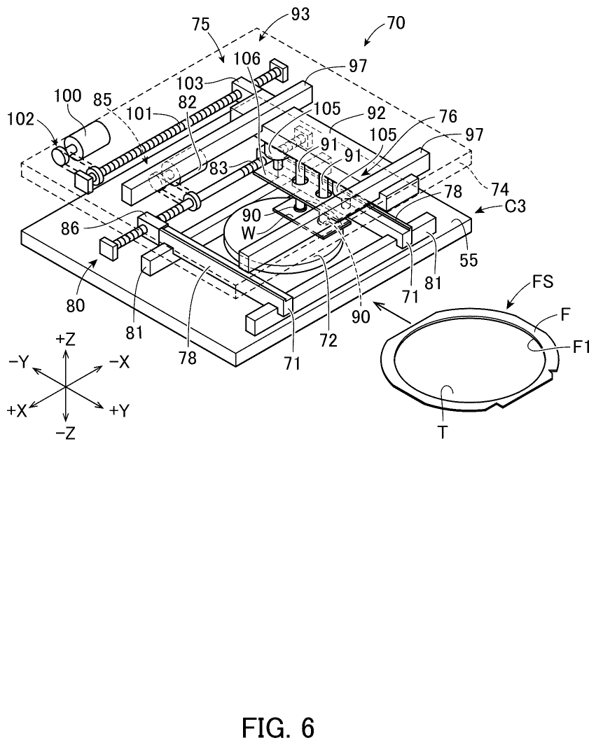

The workpiece W may be any processible piece and may be represented by, for example, a plate-shaped member in a rectangular planar shape, such as a PCB (Printed Circuit Board) substrate. While the workpiece W held on the chuck table 14 is being cut and machined, the workpiece W is attached to a tape T in a frame set FS, where the tape T is attached to a ring frame F so as to cover an opening F1 in the ring frame F. In the present embodiment, a form where the workpiece W is attached to the tape T on the frame set FS is referred to as a workpiece set WS. In other words, the workpiece set WS is formed by integrating the ring frame F and the workpiece W with the tape T attached thereto. In the present embodiment, an upper surface of the tape T serves as an attaching surface, by which the tape T is attached to the ring frame F and the workpiece W. The workpiece set WS is formed by a tape mounter 70 (see FIG. 6), which will be described later. The tape T may be represented by, for example, an adhesive tape having an adhesive layer applied to a tape base material.

The cutting apparatus 1 includes a housing 10 in a rectangular parallelepiped form, which encloses a processing space for machining, and a supporting base 13, which is adjacent to the housing 10 and forms a standby space and a cleaning space. A central area of an upper surface of the supporting base 13 is open toward the inside of the housing 10, and the opening is covered with a movable plate 15 that is movable together with the chuck table 14 and a bellows-shaped waterproof cover 16. Below the waterproof cover 16, a process-feeding assembly 21 (see FIG. 2) for moving the chuck table 14 in the X-axis direction, i.e., a process-feeding direction, is provided. FIG. 1 shows the chuck table 14 moved outside the housing 10 and standing by on the supporting base 13.

The chuck table 14 has a holder surface 17 made of a porous ceramic material, and the workpiece W is suctioned and held against the holder surface 17 by a negative pressure generated at the holder surface 17. Around the chuck table 14, four air-driven clamps 18 are arranged. The clamps 18 hold the ring frame F in the workpiece set WS from four sides. Above the chuck table 14, a pair of guides 19 extending in the Y-axis direction are provided. By the pair of guides 19 moving closer to or farther from each other in the X-axis direction, the workpiece set WS is located at a particular position in the X-axis direction with respect to the chuck table 14.

FIG. 2 is an internal perspective view of the cutting apparatus according to the embodiment. As shown in FIG. 2, on a base table 20 inside the housing 10 and the supporting base 13 (see FIG. 1), the process-feeding assembly 21 of a ball-screw type is arranged. The process-feeding assembly 21 may move the chuck table 14 in the process-feeding direction, which is the X-axis direction. Moreover, on the base table 20, a vertical wall 22 in a form of a gate that saddle a movable path of the chuck table 14 is provided. The vertical wall 22 includes an index-feeding assembly 25 for moving processing units 24 in an index-feeding direction, which is the Y-axis direction, and cut-feeding assemblies 26 for moving the processing units 24 in a cut-feeding direction, which is the Z-axis direction. In the present embodiment, two pairs of processing unit 24 and cut-feeding assembly 26 are arranged along the Y-axis direction.

To a spindle in each processing unit 24, a cutting blade 28 to process the workpiece W in the workpiece set WS held on the chuck table 14 is attached. The cutting blades 28 may be, for example, made of diamond abrasive grains solidified with a binding agent into a shape of a disk.

Returning to FIG. 1, on a side surface 11 of the housing 10, a first conveyer 30 (conveyer) for conveying the workpiece set WS to the chuck table 14 is provided. The first conveyer 30 includes a driving assembly 31 of a ball-screw type mounted on the side surface 11 of the housing 10, a slide arm 32 that may be moved by the driving assembly 31 slidably in the Y-axis direction, and an inverting assembly 33, of which base is supported on a lower end of the slide arm 32. The first conveyer 30 further includes a clamp 35 and a workpiece holder 36 provided at a tip end (an end on the +X side) of the inverting assembly 33.

The inverting assembly 33 is configured to rotate the clamp 35 and the workpiece holder 36 about the X-axis in increments of 180 degrees, and rotate the clamp 35 and the workpiece holder 36 such that either one of the clamp 35 or the workpiece holder 36 is selectively located toward the −Y side. The clamp 35 includes gripping pieces that open or close vertically to clamp and hold an end portion of the ring frame F. The workpiece holder 36 may, when located at the position toward the −Y side by the inverting assembly 33, suction a lower surface of the workpiece W and hold the workpiece W by an upper surface thereof.

On a +Y side of the chuck table 14, a cleaning device 38 for cleaning a processed workpiece set WS is provided. The cleaning device 38 may lower a spinner table 39 holding the workpiece set WS to descend inside the supporting base 13 and clean the workpiece set WS by jetting cleaning water toward the workpiece set WS while the workpiece set WS is rotated at high speed. Thereafter, the cleaning device 38 may dry the workpiece set WS by jetting dry air instead of the cleaning water at the workpiece set WS.

On the side surface 11 of the housing 10, a second conveyer 40 that may convey the workpiece set WS between the chuck table 14 and the spinner table 39 is further provided. The second conveyer 40 includes a driving assembly 42 of a ball-screw type mounted on the side surface 11 of the housing 10, a slider 43 that may be moved by the driving assembly 42 slidably in the Y-axis direction, and a lift/lower device 44 supported at a lower end of the slider 43.

The second conveyer 40 further includes a conveyer pad 46, which is provided below the lift/lower device 44. The conveyer pad 46 is movable in the Z-axis direction, i.e., the up-down direction, by the lift/lower device 44 being driven. The conveyer pad 46 may suction an upper surface of the ring frame F of the workpiece set WS to hold the workpiece set WS. By driving the lift/lower device 44 and lowering the conveyer pad 46, the conveyer pad 46 holding the workpiece set WS may place the workpiece set WS on the chuck table 14 or may hold the workpiece set WS placed on the chuck table 14. Furthermore, by driving the lift/lower device 44 and lifting the conveyer pad 46, the conveyer pad 46 may be retracted so as not to interfere with the first conveyer 30.

On a surface of the housing 10 on the −Y side, the display device 48 including, for example, a monitor of a touch-panel type is provided. On the display device 48, an operation screen may be displayed. In the operation screen, information including processing conditions may be shown, and such processing conditions may be set through the operation screen. Further, the cutting apparatus 1 includes a controller (not shown) that may control overall behaviors of the units and the assemblies in the cutting apparatus 1. The controller includes, for example, a processor, which may execute various processes, and a memory. The memory may include one or more storage media including, for example, a ROM (Read Only Memory) and a RAM (Random Access Memory), depending on the usage of the cutting apparatus 1. The memory may store, for example, a controlling program for controlling the units and the assemblies in the cutting apparatus 1 and programs for processing the workpieces W, which will be described later.

On the supporting base 13, a lift/lower assembly 50 is provided adjacent to the chuck table 14. The lift/lower assembly 50 is configured to move containers C1-C3 that are stacked in three tiers in the Z-axis direction, i.e., the up-down direction. The lift/lower assembly 50 includes a driving assembly of a ball-screw type that may move a stage 51, on which the containers C1-C3 are stacked in the Z-axis direction. By driving the lift/lower assembly 50, height positions (positions in the Z-axis direction) of the containers C1-C3 may be controlled.

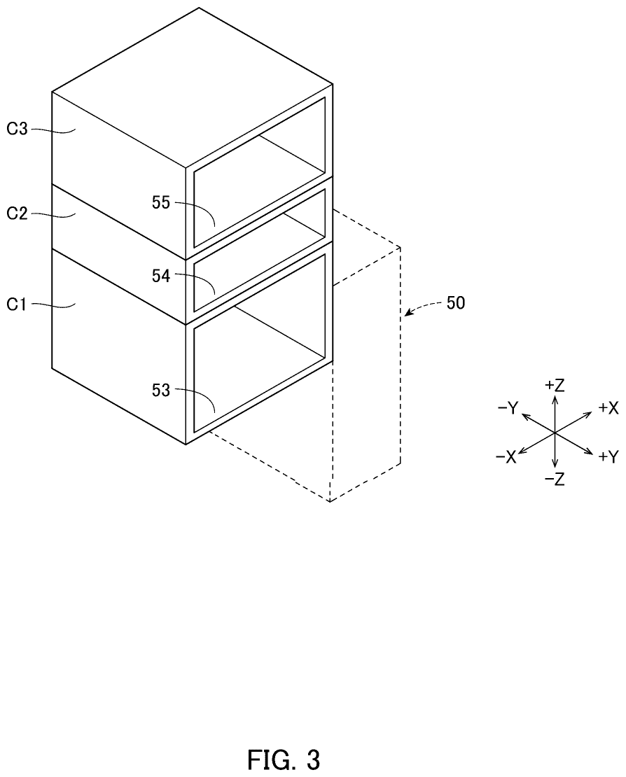

FIG. 3 is a perspective view of the containers according to the embodiment, in which illustrations of the interior of the containers C1-C3 are omitted. As shown in FIG. 3, the containers C1-C3, stacked vertically in three tiers, have box-shaped bodies, each being open on the +Y side. The three containers C1-C3 are in different sizes in the Z-axis direction but are in an equal size in the X-axis. Among the containers C1-C3 stacked vertically in three tiers, an inner space of the lowermost container C1 forms a frame cassette area, and a bottom of the frame cassette area forms a frame cassette stage 53. Among the containers C1-C3 stacked vertically in three tiers, an inner space of the container C2 in the middle forms a frame cassette area, and a bottom of the frame cassette area forms a workpiece cassette stage 54. Further, among the containers C1-C3 stacked vertically in three tiers, an inner space of the uppermost container C3 forms an attaching area, and a bottom of the attaching area forms an attaching stage 55.

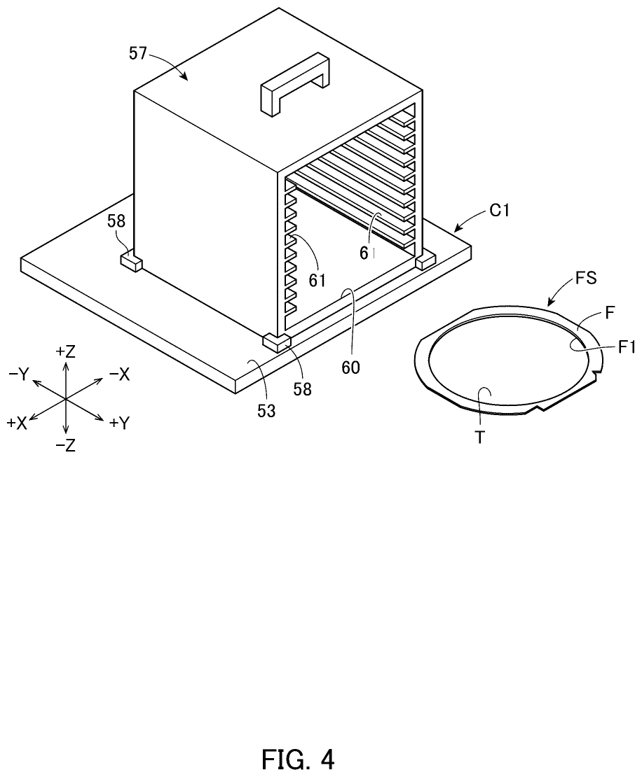

FIG. 4 is a perspective view of the interior of the lowermost container according to the embodiment. As shown in FIG. 4, on the frame cassette stage 53, a frame cassette 57 for storing one or more frame sets FS is placed. The frame cassette 57 may store not only the frame sets FS but also workpiece sets WS, in each of which a workpiece W is attached to the frame set FS. However, in paragraphs below, a case where the frame cassette 57 stores the frame sets FS will be described. On the frame cassette stage 53, positioning members 58 to define positions of four corners of the frame cassette 57 are provided. Each positioning member 58 is formed in a shape of L in a top plan view, and in the present embodiment, four positioning members 58 in total, one of which is not shown, are provided to the single frame cassette 57. By the positioning members 58 abutting the four corners of the frame cassette 57, the frame cassette 57 is located at a particular position on the frame cassette stage 53.

The frame cassette 57 has an opening 60 on the +Y side and is loaded or unloaded with the frame set FS by the first conveyer 30 (see FIG. 1) through the opening 60. The frame cassette 57 has a plurality of shelves 61 inside for storing a plurality of frame sets FS. The shelves 61 are formed so as to project inward by a predetermined amount from inner surfaces of side walls on each side in the X-axis direction of the frame cassette 57 and partially support ends of the frame set FS in the X-axis direction being stored.

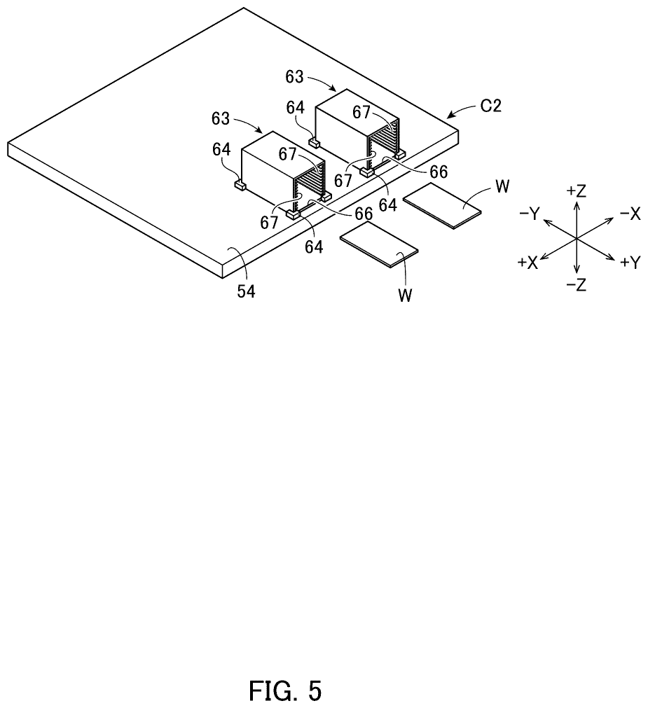

FIG. 5 is an interior perspective view of the container in the middle tier according to the present embodiment. As shown in FIG. 5, on the workpiece cassette stage 54, two workpiece cassettes 63 for storing workpieces W are placed side by side in the X-axis direction. On the workpiece cassette stage 54, positioning members 64 to define positions of four corners of each workpiece cassette 63 are provided. Each positioning member 64 is formed in a shape of L in a top plan view, and in the present embodiment, eight positioning members 64 in total, two of which are not shown, for the two workpiece cassettes 63 are provided. By the positioning members 64 abutting the four corners of each workpiece cassette 63, the workpiece cassettes 63 are located at particular positions on the workpiece cassette stage 54.

Each workpiece cassette 63 has an opening 66 on the +Y side and is loaded or unloaded with the workpiece W by the first conveyer 30 (see FIG. 1) through the opening 66. The workpiece cassette 63 has a plurality of shelves 67 inside for accommodating a plurality of workpieces W. The shelves 67 are formed so as to project inward by a predetermined amount from inner surfaces of side walls on each side in the X-axis direction of the workpiece cassette 63 and partially support ends of the workpieces W in the X-axis direction being stored. As such, each workpiece W supported by the shelf 67 is exposed at a lower surface thereof except for the end regions on the both sides in the X-axis direction, allowing the workpiece holder 36 of the first conveyer 30 to contact and suction to hold the workpiece W from below.

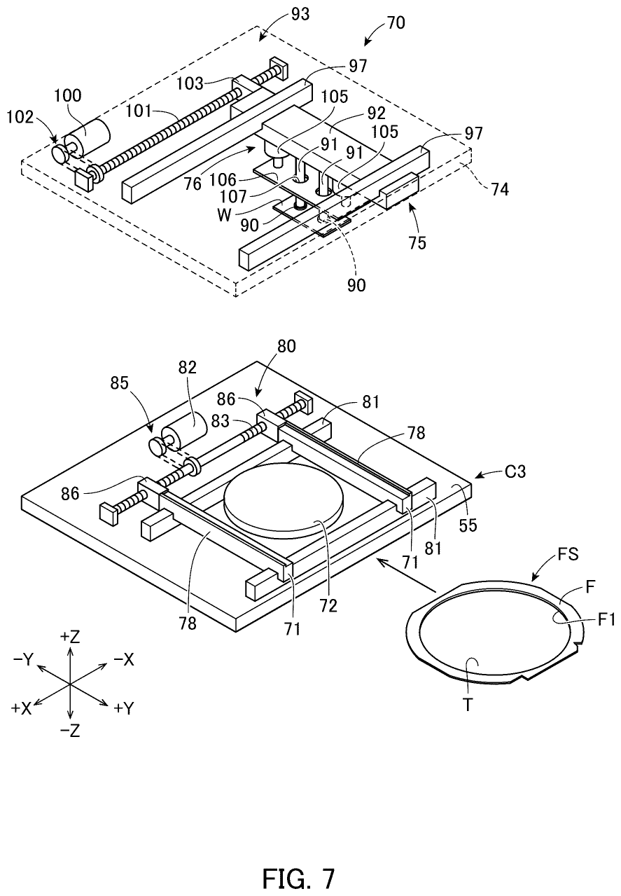

FIG. 6 is an interior perspective view of the uppermost container C3 according to the present embodiment. FIG. 7 is an exploded view of the uppermost container C3 shown in FIG. 6. As shown in FIGS. 6 and 7, inside the uppermost container C3, a tape mounter 70 is installed. The tape mounter 70 includes frame rails 71 and a table 72 arranged on the attaching stage 55, and a workpiece movement assembly 75 and an attaching assembly 76 arranged on a downward surface of a ceiling 74 of the container C3.

Two frame rails 71 extend in the Y-axis direction and are arranged apart from each other in the X-axis direction with the table 72 interposed therebetween. The frame rails 71 support the ring frame F of the frame set FS on upper surfaces thereof. On the upper surface of each frame rail 71, a positioning rib 78 extending in the Y-axis direction in parallel to the frame rail 71 is formed, and the ring frame F placed (supported) on the upper surfaces of the frame rails 71 are interposed between the positioning ribs 78 in the X-axis direction to be located at a particular position in the X-axis direction.

The two frame rails 71 may be moved by a distance adjustment assembly 80 to adjust a distance therebetween in the X-axis direction. The distance adjustment assembly 80 includes a pair of guide rails 81 arranged on the attaching stage 55 in parallel to the X-axis direction. The guide rails 81 support the frame rails 71 from below and guide the frame rails 71 moving in the X-axis direction.

The distance adjustment assembly 80 further includes a motor 82, a ball screw 83 arranged in parallel to the X-axis direction, a transmission assembly 85 including a pulley and a belt to transmit rotation of the motor 82 to the ball screw 83, and two nut portions 86 screwed to the ball screw 83. To each of the nut portions 86, a respective one of the frame rails 71 is fixed. In the distance adjustment assembly 80, by driving the motor 82, the ball screw 83 is rotated, and the nut portions 86 and the frame rails 71 are moved in directions to separate from or approach each other along the X-axis direction, thereby adjusting the distance between the two frame rails 71.

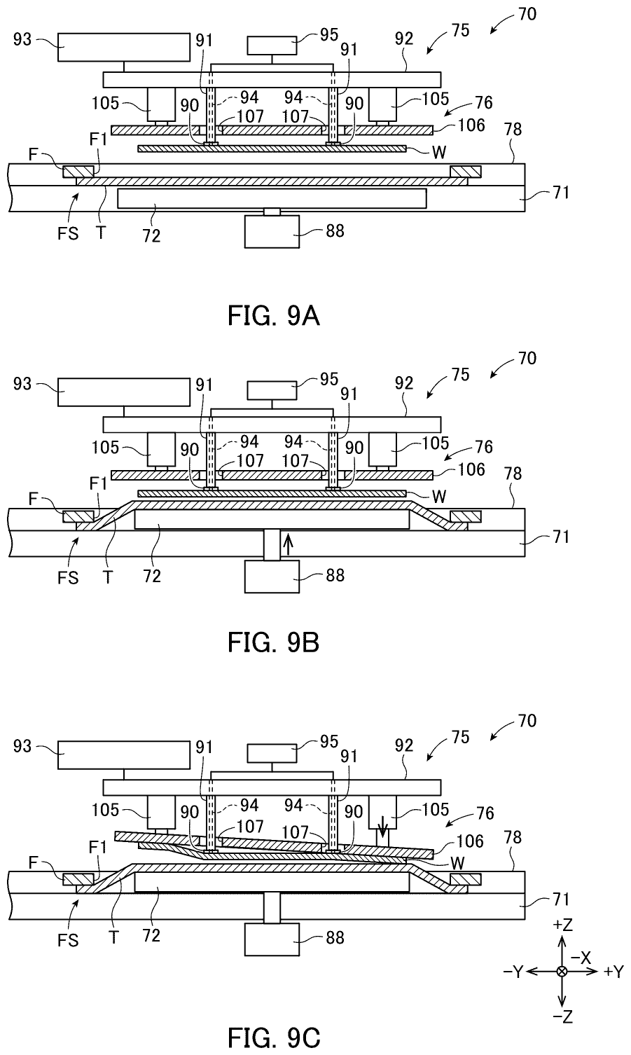

In the present embodiment, the table 72 is formed of a disk larger than the workpiece W in planar size. The table 72 is movable in the up-down direction via a lift/lower device 88 (not shown in FIGS. 6-7 but shown in FIGS. 9A-9B) such as a cylinder. More specifically, the table 72 is movable in the up-down direction by driving the lift/lower device 88 between a position, at which the table 72 is below and apart from the tape T on the frame set FS supported by the frame rails 71, and a position, at which the table 72 lifts the tape T above the upper surface of the ring frame F.

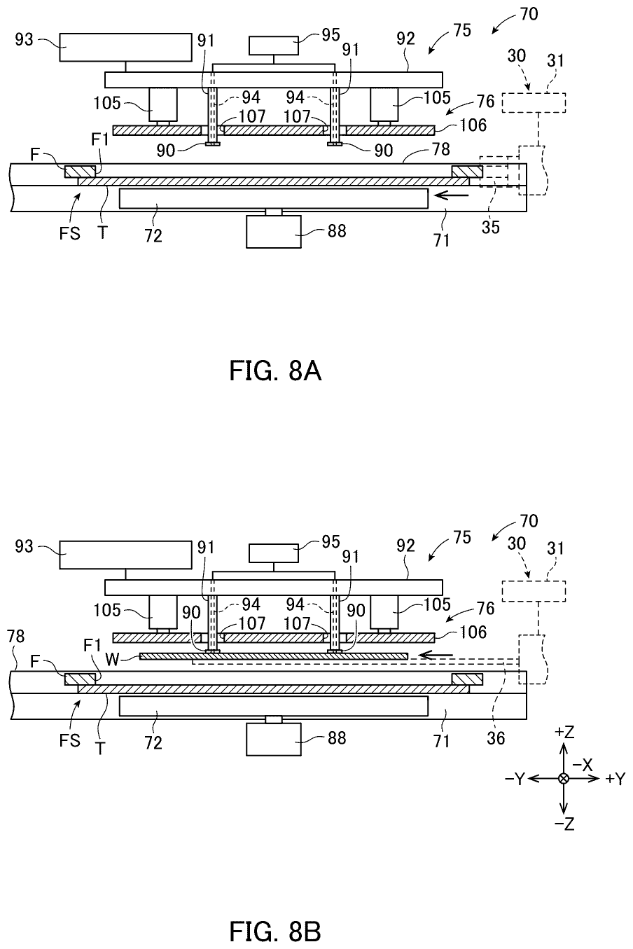

The workpiece movement assembly 75 includes two suction cups 90 serving as suctioning portions, two supporting pipes 91 extending in the up-down direction to support the suction cups 90 at lower ends thereof, a supporting base 92 to which upper ends of the supporting pipes 91 are connected, and a horizontal movement assembly 93. In each supporting pipe 91 and each supporting base 92, a suction path 94 (see FIG. 8A) is formed. Through the suction path 94, the suction cup 90 is in communication with a suction source 95 (see FIG. 8A) and is enabled to suction and hold the upper surface of the workpiece W.

The horizontal movement assembly 93 includes a pair of guide rails 97 arranged in parallel to the X-axis direction on the downward surface of the ceiling 74. The guide rails 97 support the supporting base 92 from above and guide the supporting base 92 moving in the X-axis direction.

The horizontal movement assembly 93 further includes a motor 100, a ball screw 101 parallel to the X-axis direction, a transmission assembly 102 including a pulley and a belt to transmit rotation of the motor 100 to the ball screw 101, and a nut portion 103 screwed to the ball screw 101. To the nut portion 103, the supporting base 92 is fixed. In the horizontal movement assembly 93, by driving the motor 100 to rotate, the ball screw 101 is rotated, causing the nut portion 103, the supporting base 92, the supporting pipes 91, and the suction cups 90 to move in the X-axis direction. As such, the workpiece W held by the suction cups 90 may move in the X-axis direction to a position, where the workpiece W is attached to the tape T in the frame set FS being supported by the frame rails 71.

The attaching assembly 76 includes a pair of cylinders 105 forming a pressing assembly and a pressing plate 106 connected to lower ends of the cylinders 105. The pair of cylinders 105 are arranged to be spaced from each other by a predetermined distance in the Y-axis direction. The pressing plate 106 is formed to be larger than the workpiece W in a planar shape. Preferably, the pressing plate 106 has flexibility to elastically deform from a flat state into a form, in which, for example, a portion thereof at a center in the Y-axis direction curves downward. Holes 107 (see FIG. 8A) are formed in the pressing plate 106, and the supporting pipes 91 penetrate the pressing plate 106 through the holes 107. In the attaching assembly 76, the pair of cylinders 105 are driven with time delay, and the pressing plate 106 is elastically deformed and moved downward to a flat state, thereby causing the workpiece W, having been moved above the tape T by the workpiece movement assembly 75, to be pressed against and attached to the tape T.

Next, a method for forming the workpiece set WS in the above embodiment will be described. According to the present embodiment, the frame sets FS, in each of which the tape T is attached to the ring frame F, are stored in the frame cassette 57, and the workpieces W are stored in the workpiece cassette 63.

In the method for forming the workpiece set WS according to the present embodiment, a frame set conveying step, in which the frame set FS stored in the frame cassette 57 of the lowermost container C1 is moved to and supported by the frame rails 71 in the uppermost container C3, is performed. In the frame set conveying step, the clamp 35 is located toward the −Y side, which is the side where the container C1 is located (see FIG. 1), through the inverting assembly 33 in the first conveyer 30. Meanwhile, the stage 51 in the lift/lower assembly 50 is moved in the Z-axis direction so that the frame set FS to be conveyed is located at a position corresponding to the clamp 35 in the Z-axis direction, and the stage 51 and the vertically stacked three containers C1-C3 are moved in the Z-axis direction.

Next, the driving assembly 31 in the first conveyer 30 is driven, and the clamp 35, with the gripping pieces thereof being separated, is moved in the −Y-axis direction toward the frame set FS stored in the frame cassette 57. With the gripping pieces of the clamp 35 gripping the end of the ring frame F, the clamp 35 and the frame set FS are drawn outward from the container C1 toward the +Y side of the frame cassette 57 through the driving assembly 31.

In the state where the clamp 35 and the frame set FS are drawn out, the stage 51 in the lift/lower assembly 50 is moved in the −Z-axis direction, and the frame set FS held by the clamp 35 is relatively moved to a height of frame rails 71 in the uppermost container C3. Thereafter, as shown in FIG. 8A, the clamp 35 and the frame set FS are moved in the −Y-axis direction through the driving assembly 31, and the frame set FS is placed on the frame rails 71. After the frame set FS is placed on the frame rails 71, the clamp 35 releases the frame set FS and is moved in the +Y-axis direction through the driving assembly 31 to be retracted outside the container C3.

Before or after the frame set conveying step, a workpiece conveying step is performed. In the workpiece conveying step, the workpiece W stored in the workpiece cassette 63 of the container C2 in the middle tier is moved to and held by the suction cups 90 in the uppermost container C3. In particular, in the workpiece conveying step, the workpiece holder 36 is located toward the −Y side, on which the container C2 is located, by the inverting assembly 33 in the first conveyer 30. Meanwhile, the stage 51 in the lift/lower assembly 50 is moved in the Z-axis direction so that the vertically stacked three containers C1-C3 are moved in the Z-axis direction and the workpiece W to be conveyed is located at a position corresponding to the workpiece holder 36 in the Z-axis direction.

Next, the driving assembly 31 in the first conveyer 30 is driven, and the workpiece holder 36 is moved in the −Y-axis direction to a position below the workpiece W stored in the workpiece cassette 63. With the workpiece holder 36 holding the lower surface of the workpiece W, the workpiece holder 36 and the workpiece W are drawn outward from the container C2 toward the +Y side of the workpiece cassette 63 through the driving assembly 31.

In the state where the workpiece holder 36 and the workpiece W are drawn out, the stage 51 in the lift/lower assembly 50 is moved in the −Z-axis direction, and the workpiece W held by the workpiece holder 36 is relatively moved to a height of the suction cups 90 in the workpiece movement assembly 75 in the uppermost container C3. Thereafter, as shown in FIG. 8B, the workpiece holder 36 and the workpiece W are moved in the −Y-axis direction through the driving assembly 31, and the upper surface of the workpiece W is suctioned to be held by the suction cups 90. As the suction cups 90 suction and hold the workpiece W, the workpiece W is released from the holding force of the workpiece holder 36, and the workpiece holder 36 is moved in the +Y-axis direction through the driving assembly 31 to be retracted outside the container C3.

After the frame set conveying step and the workpiece conveying step are performed, a workpiece attaching step, in which the workpiece W is attached to the tape T on the frame set FS, is performed. In the workpiece attaching step, as shown in FIG. 9A, while the workpiece W suctioned and held by the suction cups 90 is located above the tape T on the frame set FS, the horizontal movement assembly 93 in the workpiece movement assembly 75 is driven. Accordingly, the workpiece W is moved relative to the tape T on the frame set FS, which is supported on the frame rails 71, in the X-axis direction and the attaching position of the workpiece W with respect to the tape T in the X-axis direction is adjusted.

Before or after the workpiece W is moved in the X-axis direction, as shown in FIG. 9B, the table 72 is lifted by the lift/lower device 88 being driven. As the table 72 ascends, the tape T on the frame set FS supported by the frame rails 71 is lifted to some extent, and the table 72 supports the lower surface (the surface opposite to the attaching surface) of the tape T, such that the tape T approaches the lower surface of the workpiece W being suctioned and held by the suction cups 90, but not contacting each other, maintaining a slight gap therebetween. Note that although FIG. 9B shows the tape T as being stretched and lifted by the ascending table 72, in practice, the tape T is moved within a slack range of the tape T attached to the ring frame F.

Next, as shown in FIG. 9C, the pressing plate 106 is moved downward by the cylinders 105 in the attaching assembly 76, and the workpiece W held by the suction cups 90 through the pressing plate 106 is pressed against and attached to the upper surface (attaching surface) of the tape T. In particular, solely one of the two cylinders 105 aligning in the Y-axis direction, e.g., the cylinder 105 on the +Y side in FIG. 9C, is driven, thereby tilting the pressing plate 106 and pressing the workpiece W against the tape T from an outer peripheral edge on the +Y side of the workpiece W.

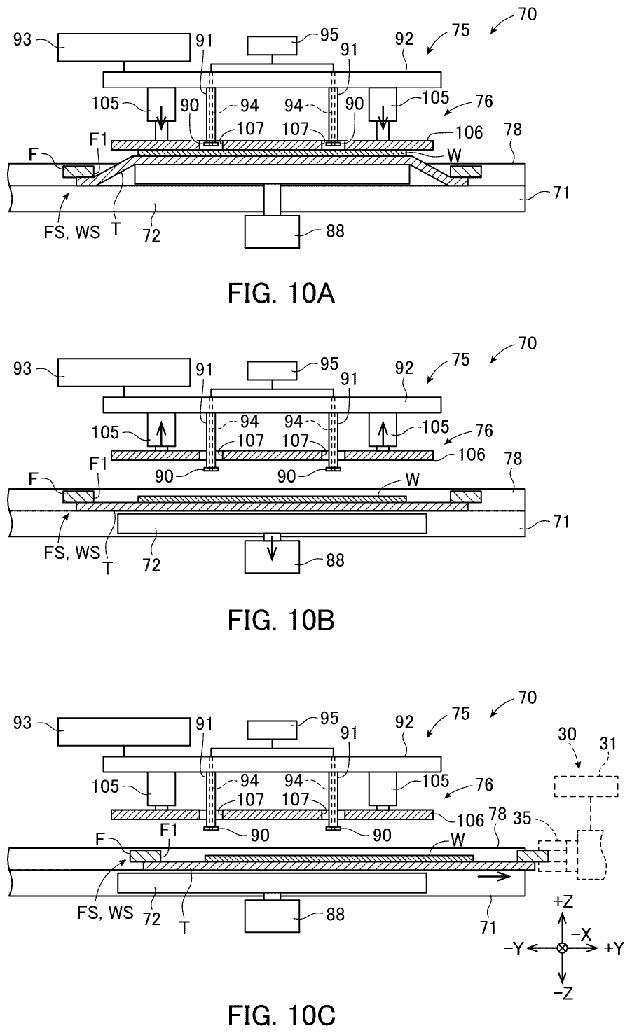

Thereafter, as shown in FIG. 10A, the other cylinder 105, e.g., the cylinder 105 on the −Y side, is driven, and the tilted pressing plate 106 gradually returns to the horizontal state. Accordingly, an area to be pressed by the pressing plate 106 gradually expands from the +Y side toward the outer peripheral edge of the workpiece W on the −Y side, and the attachment of the workpiece W to the tape T progresses gradually from the +Y side toward the −Y side. While the workpiece W is being pressed against the tape T by the pressing plate 106, the tape T is supported by the table 72, so that the workpiece W is supported from below through the tape T, and the workpiece W is released from the suctioning and holding force of the suction cups 90.

As the workpiece W is completely attached to the tape T, the workpiece set WS, in which the workpiece W is attached to the tape T on the frame set FS, is formed. After attaching of the workpiece W to the tape T is completed, as shown in FIG. 10B, the table 72 is lowered by the lift/lower device 88 being driven and is separated from the lower surface of the tape T on the frame set FS. Further, the pressing plate 106 is lifted by the cylinders 105 being driven and is separated from the workpiece W attached to the tape T. Note that, according to the above embodiment, the pressing plate 106 is tilted. However, the pressing plate 106 may be convexly curved downward at the center thereof and moved to contact the workpiece W from the end on the +Y-side, and the curved pressing plate 106 may be returned to the flat shape, so that the area in which the workpiece W is attached to the tape T expands in the −Y-axis direction, thereby causing the tape T to attach to the entire lower surface of the workpiece W. Moreover, the number of the cylinders 105 is not limited to two (a pair) but may be three or more.

For attaching two or more workpieces W to the tape T on the same frame set FS, after attaching the first workpiece W, the workpiece conveying step and the workpiece attaching step described above are repeatedly in the same manner. Accordingly, two or more workpieces W may be attached to the tape T without arranging a plurality of tables to hold the workpieces W.

After the workpiece attaching step, a workpiece set conveying step, in which the workpiece set WS formed in the workpiece attaching step is conveyed to the chuck table 14, is performed. In the workpiece set conveying step, the clamp 35 is located toward the −Y side, which is the side where the container C3 is located, by the inverting assembly 33 in the first conveyer 30. Meanwhile, the stage 51 in the lift/lower assembly 50 is moved in the Z-axis direction so that the vertically stacked three containers C1-C3 are moved in the Z-axis direction and the workpiece set WS to be conveyed is located at the position in the Z-axis direction corresponding to the clamp 35.

Next, the driving assembly 31 in the first conveyer 30 is driven, and the clamp 35, with the gripping pieces thereof being separated, is moved in the −Y-axis direction toward the workpiece set WS on the frame rails 71. With the gripping pieces of the clamp 35 gripping the end of the ring frame F in the workpiece set WS, the clamp 35 and the workpiece set WS are drawn outward from the container C3 toward the +Y side by the driving assembly 31. Accordingly, the workpiece set WS is moved to and held on the chuck table 14 (see FIG. 1), completing the workpiece set conveying step. After the workpiece set conveying step is completed, the workpiece set WS held on the chuck table 14 is cut and processed by the processing unit 24.

The tape mounter 70 according to the present embodiment includes the workpiece movement assembly 75 capable of moving the workpiece W. Accordingly, in a case where a plurality of workpieces W are to be attached to the tape T on the frame set FS, the workpiece conveying step and the workpiece attaching step described above are repeatedly performed, and the workpieces W may be moved and attached to the tape T one by one. Therefore, even with the increased number of the workpieces W, the workpieces W may be attached to the tape T without requiring additional devices or assemblies for holding the workpieces W, and the tape mounter may avoid complexity in the structure thereof.

In the tape mounter 70, the tape T is supported from below by the table 72, while the workpiece W is attached from above to the tape T by the attaching assembly 76. Therefore, according to this tape mounter 70, air bubbles that may enter between the tape T and the workpiece W may be reduced, even if the time required for attaching the workpiece W to the tape is shortened compared to conventional configurations where a roller is rolled over the tape T to attach the tape T to the upper surface of the workpiece W. In other words, compared to the conventional configuration, the tape mounter 70 of the present embodiment is enabled to attach the workpiece W to the tape T preferably while shortening the attaching time. Furthermore, since the workpiece W is pressed against and attached to the tape T attached to the ring frame F, the attaching assembly 76 may be arranged more space-efficiently in the tape mounter 70 compared to conventional arrangements.

Furthermore, in the present embodiment, the frame cassette stage 53 on which the frame cassette 57 is placed, the workpiece cassette stage 54 on which the workpiece cassettes 63 are placed, and the tape mounter 70 are all arranged collectively in the containers C1, C2, C3, respectively, in the lift/lower assembly 50. Therefore, the cutting apparatus 1 may cut the workpiece W and form the workpiece set WS by attaching the workpiece W to the tape T simultaneously. Thus, when cutting the workpiece W requires a long processing time, the processing time may be effectively used to form the workpiece set WS, thereby improving the process efficiency. Moreover, a workpiece set WS may be formed by utilizing a time that includes the processing time and a time for cleaning another workpiece set WS having been through the cutting process.

While an embodiment of the present invention has been described, embodiments of the present disclosure may not necessarily be limited to the configuration described above or in the modified example but may be modified, substituted, or altered in various ways without departing from the spirit of the technical idea of the present disclosure. Furthermore, if the technical idea of the present disclosure may be realized in a different way due to technological progress or other derived technology, it may be implemented with use of the method. Therefore, the claims cover all embodiments that may be included within the scope of the technical idea of the present disclosure.

For example, the supporting pipe 91 to support the suction cup 90 may be formed of a tubular member in a form of bellows that may expand or contract in the Z-axis direction. In this configuration, when the cylinder 105 is driven and the workpiece W is pressed against the tape T with the pressing plate 106, the supporting pipes 91 may expand or contract to maintain the workpiece W to be suctioned by the suction cups 90 even after the workpiece W is attached to the tape T. Therefore, for example, when the pressing plate 106 is curved to protrude downward at the center thereof, the workpiece W may be maintained suctioned by the suction cups 90.

For another example, for forming the workpiece set WS, the workpiece W or other conveying target may not necessarily be moved vertically by lifting or lowering the containers C1-C2 through the lift/lower assembly 50, but the first conveyer 30 may have a Z-axis movement assembly that may move the workpiece W or the conveying target in the Z-axis direction.

Moreover, the number of frame cassette 57 to be placed on the frame cassette stage 53 and the number of workpiece cassettes 63 to be placed on the workpiece cassette stage 54 are not necessarily limited but may be increased or decreased optionally. In other words, the number of frame cassette(s) 57 mounted on the frame cassette stage 53 may be one or more, and in the case where solely one frame cassette 57 is mounted, the workpiece set WS having been processed may be returned to the location, from which the frame set FS was unloaded.

In the present embodiment, the processing unit 24 has been illustrated as the example of the processing apparatus movable in two axes, but the processing apparatus is not necessarily limited to the two-dimensionally movable configuration. For example, the processing unit may be a cutting apparatus movable in a single axis, a laser-processing cutting apparatus, or a cluster apparatus combining these or other types of processing devices. For another example, the processing apparatus may be a grinding apparatus for grinding one surface of the workpiece W using a grinding wheel in a processing unit, or may be a polishing apparatus for polishing one surface of the workpiece W using a polishing pad in a processing unit.

Moreover, the workpiece W to be processed may be, other than the above-described configurations, a semiconductor substrate such as silicon or gallium arsenide, an inorganic material substrate such as ceramic, glass, or sapphire, or a package substrate of a semiconductor product.

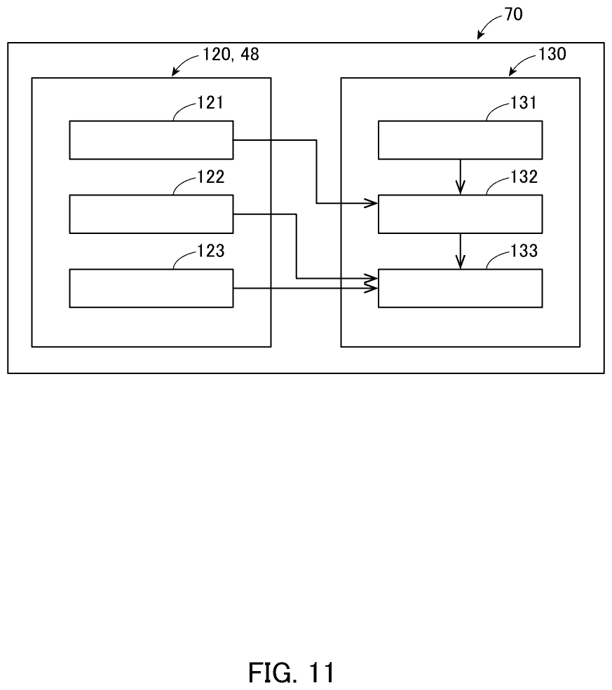

Furthermore, a modified example as shown in FIGS. 11-13 may be adopted. FIG. 11 is a block diagram to illustrate an input device and a controller according to the modified example of the embodiment. In the modified example, the display device 48 (see FIG. 1) including the aforementioned monitor with the touch panel is provided with a function of an input device 120 for, for example, inputting information such as processing conditions described below. Furthermore, in the modified example, the tape mounter 70 includes a controller 130, which is similar to the controller (not shown) described above in the above embodiment but is provided with functions described below. In the modified example, the tape mounter 70 includes the input device 120 and the controller 130; however, optionally, the input device 120 and the controller 130 provided to serve for the entire cutting apparatus 1 may be used for operating the tape mounter 70.

As shown in FIG. 11, the input device 120 includes a ring frame model setting unit 121, a workpiece size setting unit 122, and a workpiece number setting unit 123. The input device 120 may be composed of the touch panel included in the display device 48. The input device 120 receives various inputs relating to the cutting apparatus 1, including the tape mounter 70, from the operator and transmits the inputs to the controller 130.

The ring frame model setting unit 121 receives and sets a model of the ring frame F. The workpiece size setting unit 122 receives and sets vertical and horizontal dimensions of the workpiece W having a shape of, for example, rectangle. The workpiece number setting unit 123 receives and sets the number of workpieces W provided to the frame set FS to be attached to the tape T by the attaching assembly 76.

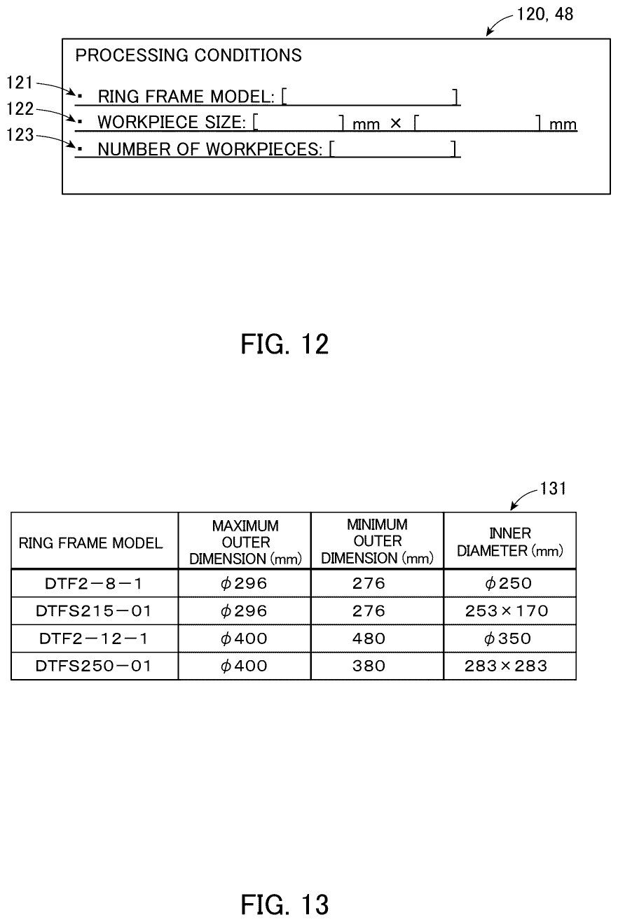

FIG. 12 illustrates an example of an input screen in the input device in the modified example. For example, as shown in FIG. 12, the input screen in the input device 120 may be displayed in a part or the entirety of the monitor in the display device 48. In the input screen shown in FIG. 12, text such as “Ring Frame Model,” “Workpiece Size,” and “Number of Workpieces” may be displayed as processing condition items, and the operator may enter information concerning the conditions in brackets displayed adjacent to the text, e.g., on the right in FIG. 12. As such, in the input screen shown in FIG. 12, the area displaying the text “Ring Frame Model” functions as an input interface of the ring frame model setting unit 121, the area displaying the text “Work Size” functions as an input interface of the workpiece size setting unit 122, and the area displaying the text “Number of Workpieces” functions as an input interface of the workpiece number setting unit 123.

Returning to FIG. 11, the controller 130 in the modified example includes a ring frame data table 131, a ring frame inner diameter setting unit 132, and a maximum attachable workpiece number calculating unit 133, which are expressed as functional blocks. These functional blocks are implemented by the controller 130 executing a program stored in a memory in the controller 130. It should be noted that the functional blocks in the controller 130 shown in FIG. 11 illustrate merely the configurations related closely to the present disclosure, and other components that may be provided to the controller 130 are omitted.

As illustrated in FIG. 13, the ring frame data table 131 stores conditions, such as dimensions, associated with the ring frame model of the ring frame F. In the ring frame data table 131 shown in FIG. 13, each ring frame model is associated with conditions such as a diameter, which is a maximum outer dimension, a width, which is a minimum outer dimension, and an inner diameter. As shown in, for example, FIG. 4, the ring frame F has a shape with multiple cutouts on an outer circumferential edge; therefore, the maximum outer dimension is a diameter, and the minimum outer dimension is a width between two parallel sides. As to the inner diameter, the ring frame of which value begins with a sign “o” has a circular inner circumference, whereas the ring frame with two dimensions separated by a sign “x” has a rectangular inner circumference.

The ring frame inner diameter setting unit 132 refers to the ring frame data table 131 based on a ring frame model input through the ring frame model setting unit 121 and sets an inner diameter of the ring frame F. The inner diameter may be selected from a column of the inner diameter in the ring frame data table 131 shown in FIG. 13.

The maximum attachable workpiece number calculating unit 133 calculates a maximum number of workpieces W attachable to the ring frame F having the inner diameter set by the ring frame inner diameter setting unit 132, based on the dimensions of the workpiece W set by the workpiece size setting unit 122. For example, the maximum attachable workpiece number calculating unit 133 may calculate the maximum attachable number of workpieces W by dividing the inner diameter of the ring frame F by a sum of a width of the workpiece W and a clearance between the adjacent workpieces W stored in advance and truncating the decimal part of the divided value.

Optionally, for the conditions and the values described above, setting values, including a plurality of setting items for cutting and machining the workpieces W, sored in the controller 130 as device data may be used.

Next, a method for processing a plurality of workpieces W attached to a single workpiece set WS by cutting with the cutting apparatus 1 that includes the tape mounter 70 in the modified example as above will be described. Prior to implementing the processing method, similarly to the method for forming the workpiece set WS described above, the frame set FS in which the tape T is attached to the ring frame F is stored in the frame cassette 57, and the workpieces W are stored in the workpiece cassette 63. In the method for processing the workpieces W in the workpiece set WS in the modified example, a condition setting step, a workpiece number setting step, a workpiece set forming step, a holding step, and a processing step are performed. In the following paragraphs, descriptions of the steps performed in the same manner as those in the above-described embodiment may be omitted or simplified.

In the method for processing the workpieces W, first, the condition setting step is performed. In the condition setting step, a model of the ring frame F is set via the ring frame model setting unit 121, and dimensions of the workpiece W are set via the workpiece size setting unit 122, based on inputs to the touch panel in the display device 48 by the operator. Further, processing conditions necessary for cutting and machining the workpieces W are input via the touch panel in the display device 48.

Furthermore, in the condition setting step, an inner diameter of the ring frame F may be set in the ring frame inner diameter setting unit 132 with reference to the ring frame data table 131, and the maximum number of attachable workpieces W may be calculated by the maximum attachable workpiece number calculating unit 133.

After the condition setting step, the workpiece number setting step, in which the number of workpieces W is set in the workpiece number setting unit 123, is performed. The number of the workpieces W refers to the number of the workpieces W to be attached to the tape T by the attaching assembly 76 in a single frame set FS, and is set through input operations to the touch panel in the display device 48 by the operator. In other words, for processing the plurality of workpieces W with the cutting apparatus 1, the number being two or greater is set in the workpiece number setting unit 123.

Furthermore, when the maximum number of attachable workpieces W is set in the condition setting step, the number of workpieces W set in the workpiece number setting step is compared with the maximum attachable number. If the entered number of the workpieces W exceeds the maximum attachable number, the operator is notified by, for example, an error alert displayed in the display device 48.

After the workpiece number setting step, the workpiece set forming step is performed. In the workpiece set forming step, the number of workpieces W set in the workpiece number setting unit 123 is attached to the tape T of a frame set FS by the attaching assembly 76 to form a workpiece set WS. In the workpiece set forming step, the frame set conveying step described in the above embodiment is performed. After the frame set conveying step, the workpiece conveying step and the workpiece attaching step in the above embodiment are repeatedly performed in accordance with the number of the workpieces W set in the workpiece number setting unit 123. More specifically, the number to repeatedly perform the workpiece conveying step and the workpiece attaching step is equal to the number of workpieces W. Accordingly, two or more workpieces W are aligned and attached to the tape T in the single frame set FS, thereby forming the workpiece set WS.

After the workpiece set forming step, the workpiece set conveying step described in the above embodiment is performed as the holding step to hold the workpiece set WS on the chuck table 14. After the holding step, a processing step to cut and process the plurality of workpieces W in the workpiece set WS held by the chuck table 14 in the holding step with the processing unit 24 is performed.

As described above, the present disclosure provides the advantageous effect that even when a plurality of workpieces are attached to a tape of a frame set, the processing apparatus may prevent complexity in the structure thereof.

What is claimed is:

1. A tape mounter configured to attach at least one workpiece to a tape, the tape being attached to a ring frame to close an opening in the ring frame, comprising:
frame rails configured to support a frame set, in which the tape is attached to the ring frame to close the opening;
a workpiece movement assembly configured to move the at least one workpiece onto the tape in the frame set supported by the frame rails;
a table configured to support a surface of the tape on an opposite side to an attaching surface of the ring frame; and
an attaching assembly configured to attach the at least one workpiece moved by the workpiece movement assembly to the attaching surface of the tape supported by the table.

2. The tape mounter according to claim 1, further comprising a workpiece number setting unit configured to set number of the at least one workpiece to be attached to the tape by the attaching assembly.

3. The tape mounter according to claim 1, further comprising a ring frame inner diameter setting unit configured to set an inner diameter of the ring frame and a workpiece size setting unit configured to set dimensions of the at least one workpiece.

4. A processing apparatus, comprising:
a chuck table configured to hold a workpiece set in which the ring frame and the at least one workpiece are integrated with the tape attached thereto;
a processing unit configured to process the at least one workpiece held by the chuck table;
a conveyer configured to convey the workpiece set to the chuck table;
a frame cassette stage for placing a frame cassette thereon, the frame cassette being configured to store the frame set, in which the tape is attached to the ring frame to close the opening;
a workpiece cassette stage for placing a workpiece cassette thereon, the workpiece cassette being configured to store the at least one workpiece; and
the tape mounter according to claim 2, the tape mounter being configured to form the workpiece set by attaching the at least one workpiece to the tape in the frame set.

5. A method for processing workpieces using the processing apparatus according to claim 4, comprising:
a workpiece number setting step including setting the number of at least one workpiece to be attached to the tape in the workpiece number setting unit, the number being at least two;
a workpiece set forming step including forming the workpiece set by operating the attaching assembly to attach the at least two workpieces, the number of which is set in the workpiece number setting unit, to the tape in the frame set;
a holding step including operating the chuck table to hold the workpiece set; and
a processing step including processing the at least two workpieces in the workpiece set held by the chuck table in the holding step.
